(19) United States
(12) Patent Application Publication
(10) Pub. No.: US 2021/0331982 A1
(43) Pub. Date: Oct. 28, 2021

(54) DRY REFRACTORY COMPOSITIONS WITH REDUCED LEVELS OF RESPIRABLE CRYSTALLINE SILICA

(71) Applicant: Allied Mineral Products, LLC, Columbus, OH (US)

(72) Inventors: Ryan Hershey, Hilliard, OH (US); Douglas Doza, Plain City, OH (US); Timothy Green, Noxon, MT (US); Dana Goski, Upper Arlington, OH (US)

(21) Appl. No.: 17/274,341

(22) PCT Filed: Sep. 9, 2019
(86) PCT No.: PCT/US2019/050183

§ 371 Date: Mar. 8, 2021

Related U.S. Application Data
(60) Provisional application No. 62/728,409, filed on Sep. 7, 2018.

(51) Int. Cl. C04B 35/14; C04B 35/63; F27D 1/00

(52) U.S. Cl. CPC C04B 35/14; C04B 35/6303; F27D 1/0006; C04B 2235/3206; C04B 2235/3217; C04B 2235/5216; C04B 2235/3418; C04B 2235/349; C04B 2235/5204; C04B 2235/5436; C04B 2235/549; C04B 2235/3409

(57) ABSTRACT

A silica-based dry refractory composition (“DRC”) comprising, by weight, about 95% to about 99.9% silica, and about 0.1 to about 5% binder, wherein the silica comprises about 40% to about 80% quartz and about 20% to about 60% fused silica, and the DRC has less than about 5% crystalline silica having a size less than 10 μm. A method of forming a refractory lining is also provided.

### BACKGROUND

The present invention is directed to silica-based (≥95% by wt. silica) dry refractory compositions (i.e., particulate refractory compositions that are installed in dry form without the addition of water or liquid chemical binders), wherein the compositions have reduced levels (in some instances, no detectable amount) of respirable crystalline silica.

Dry refractory compositions are used in a variety of applications, including the working linings and/or secondary (safety) linings in metal processing and related fields. In metal processing, dry refractory compositions are typically added to a void located around a vessel for containing molten metal, thereby providing a refractory safety lining. Furnaces used in the production of metals, especially coreless induction furnaces, are one type of metal processing vessel or system requiring a working lining.

Working linings in metal processing vessels such as furnaces typically are considered consumable materials as they wear due to the conditions within the furnace. Working linings erode, crack, or are otherwise damaged by exposure to conditions within the vessel. When a certain amount of wear to the refractory lining has occurred (e.g., when about 20% to about 40% of the lining thickness is gone), repair or replacement of the lining is necessary.

Erosion of the refractory lining due to contact with the corrosive molten metal and slag results in a gradual consumption of the refractory lining. Cracking of a refractory lining can result from the refractory material being subjected to thermal and mechanical stresses. These stresses commonly result from expansion and contraction of the lining as a result of changes in the thermal environment. Cracks allow molten metal and slag to infiltrate into the lining, resulting in an isolated failure area in the metal processing or transfer vessel. Failure of a refractory lining due to cracking is much less predictable than erosion, and such failures can be catastrophic.

Dry refractory compositions are also used in thermal insulation applications (in the metal processing field or otherwise), where repeated thermal shocks are expected. Although erosion may occur in thermal insulation refractory applications in particularly corrosive environments, failure of thermal insulation refractories typically result from cracks caused by repeated thermal shocks.

Dry refractory compositions provide superior resistance to crack propagation compared to other types of conventional refractory linings such as castables, wet ramming materials, bricks, and refractory shapes. The superior crack resistance of dry vibratable refractory linings results from the use of a bonding system that allows these linings to respond to the thermal conditions of the application by forming thermal bonds at controlled rates in predetermined temperature ranges. For example, in a metal containment application (e.g., a coreless induction furnace), the refractory lining responds to the thermal conditions of the associated molten metal vessel and any intrusions of molten metal and slag into the lining.

Dry refractory compositions (“DRC”) are also commonly referred to in the art as “dry vibratable refractories,” “dry vibratable mixes,” “dry ramming mixes,” “dry ram,” or “dry rammable refractories.” DRCs are typically installed (e.g., poured) into a void, de-aired and compacted. The DRC is then heated such that at least a first portion of the composition nearest the heat source forms strong thermal bonds and sinters.

DRCs, particularly those used as the working lining of a furnace, typically comprise refractory aggregate having a range of sizes—a distribution of sizes ranging from fine powders (e.g., 5 μm or smaller, up to around 20 mm in size, occasionally up to around 40 mm)—and a binder (also referred to as a sintering agent). Typical aggregates used in conventional dry vibratable refractory compositions include, for example: calcined alumina, fused alumina, sintered alumina (e.g., tabular alumina), sintered magnesia, fused magnesia, silica fume, quartz, fused silica, silicon carbide, boron carbide, titanium diboride, zirconium boride, boron nitride, aluminum nitride, silicon nitride, ferro silicon nitride, SiAlON (silicon-aluminum oxynitride), titanium oxide, barium sulfate, zircon, sillimanite group minerals, pyrophyllite, fireclay, calcined fireclay, carbon, wollastonite, calcium fluoride (fluorspar), spinel, chromium oxide, olivine, calcium aluminates, alumina-zirconia silicates, chromite, calcium oxide, dolomite, calcined chamotte, calcined bauxite, baddeleyite, cordierite, sintered mullite, fused mullite, fused zirconia, sintered zirconia mullite, fused zirconia mullite, sintered spinel, fused spinel, dense refractory grog, and chrome-alumina. Typical binders (also referred to as “bonding agents”) used in DRCs include various heat-activated materials. For applications requiring bond development at temperatures greater than about 600° F. (˜315° C.) inorganic bonding agents are often used, such as boron oxide (“BO”) or boric acid (“BA”).

As initially installed, a DRC lining exists in an unbonded state. The unbonded dry refractory lining exhibits no brittle behavior; it does not crack or fracture when subjected to external stresses, but instead absorbs and distributes those stresses. As the unbonded DRC lining is exposed to heat, however, it begins to form thermal bonds and sinters. In the case of the working lining of a furnace, the region nearest the hot face (the face of the lining that will be nearest the molten metal) is heated such that strong thermal bonds are formed in this region.

By way of example, when used as the working lining of a coreless induction furnace, the DRC is installed in (e.g., poured into) a void located between the induction coil and a form (e.g., an iron or steel form), de-aired and compacted. The form is then brought to a temperature sufficient to cause the formation of thermal bonds and sintering of the DRC in the region nearest the form. The form is heated, for example, by introducing molten metal into the form, energizing the coil so as to heat the form (when the form is made of a susceptible material such as iron or steel), or directly heating the form. The strongly bonded refractory in the region adjacent the hot face becomes dense and hard as it sinters, forming a hard and glassy surface that is chemically and physically resistant to penetration by molten metal and slag. The working lining can be re-used multiple times until the lining wears away and/or the lining becomes too thin. Wear processes include abrasion and chemical reactions with the slag that is produced from the molten iron.

The extent of the thermal bonding varies with the refractory composition and the thermal conditions present in a particular application. In some applications, the lining is sufficiently heated throughout its entire thickness such that all or essentially all of the DRC lining becomes strongly bonded and therefore exhibits brittle behavior. In other applications, such as when used as the working lining of an induction furnace (e.g., a coreless induction furnace), a significant temperature gradient will be present throughout the thickness of the lining, due, in part, to a cooling system (e.g., a cooling coil) used to cool the induction coil. As a result, the region furthest from the hot face remains in an unsintered and unbonded state. The intermediate region of the DRC working lining will typically form weak thermal bonds. The weakly bonded and unbonded regions of the lining retain their unsintered properties, and therefore remain capable of absorbing mechanical and thermal stresses without cracking.

Crystalline silica (silicon dioxide) can have one of three forms—quartz, cristobalite and tridymite—and is a commonly occurring geological material. Quartz is the most common naturally occurring form of crystalline silica. When quartz is non-geologically subjected to high temperatures for a sufficient long period of time, cristobalite and tridymite are formed.

Exposure to respirable crystalline silica (<10 μm, i.e., <1250 mesh) is a serious health hazard, and can be fatal. Crystalline silica exposure remains a serious threat to nearly 2 million U.S. workers, particularly those working in blasting, rock drilling, foundry work, stonecutting, and tunneling. The occupational exposure to respirable crystalline silica is associated with an increased risk for pulmonary diseases such as silicosis, chronic bronchitis, tuberculosis, and lung cancer. Silicosis, for example, occurs when respirable crystalline silica particles penetrate deep into the lungs and cause the formation of scar tissue. This reduces the lungs ability to expand and take in oxygen. Currently, there is no cure for silicosis.

While silica-based DRCs are known, the aggregate portion of such compositions is typically composed entirely of crystalline silica. Significant measures must be taken to avoid exposure to respirable crystalline silica during the installation of linings using these silica-based DRCs, as there is typically a significant amount of respirable crystalline silica in the DRC. In addition, crystalline silica (quartz, cristobalite and tridymite) particles ≥10 μm in the DRC as manufactured can become respirable size particles (<10 μm) when workers process, chip, cut, drill, or grind materials or objects that contain crystalline silica.

Because of the serious health concerns, crystalline silica is an important topic in the construction industry. Recently, the U.S. Occupational Safety and Health Administration passed new regulations reducing the permissible exposure limit (PEL) to 50 micrograms of respirable crystalline silica per cubic meter of air (μg/m³) averaged over an 8-hour day. See https://www.aiha.org/government-affairs/Documents/CRS%20Silica %20Report-04-16.pdf. The new regulation requires employers to: 1) use engineering controls to limit worker exposure, 2) develop a written exposure control plan, and 3) train workers on the health risks involved with working with silica.

### BRIEF DESCRIPTION OF THE DRAWINGS

While the specification concludes with claims particularly pointing out and distinctly claiming the invention, it is believed that the invention will be better understood from the detailed description of certain embodiments thereof when read in conjunction with the accompanying drawings.

FIG. 1 depicts the thermal expansion properties of fused silica as well as the three forms of crystalline silica.

FIGS. 2A and 2B are reflected light images of fused silica (−4/+10 mesh) from two different sources—“Type A” and “Type B”, respectively—captured using a compound microscope.

FIG. 3 is a photograph of five bars produced from a commercially available DRC following cycles of thermal shock.

FIG. 4 is a photograph of five bars produced from the DRC of Example 1 herein following cycles of thermal shock.

### DETAILED DESCRIPTION

The following detailed description describes examples of embodiments of the invention solely for the purpose of enabling one of ordinary skill in the relevant art to make and use the invention. As such, the detailed description and illustration of these embodiments are purely illustrative in nature and are in no way intended to limit the scope of the invention, or its protection, in any manner. As used herein, “mesh” refers to standard U.S. mesh sizes. For example, 1250 U.S. mesh is equivalent to a particle size of 10 μm.

The present disclosure provides silica-based DRCs such as those used for working linings (e.g., in induction furnaces), that reduce the potential exposure to respirable crystalline silica (especially during installation). As further described herein, the DRCs of the present disclosure can be installed in the same manner as a conventional DRC, such as by pouring the material into place (e.g., into a void provided between a furnace's induction coil and a metal form), and then de-airing and densifying (compacting) the DRC. De-airing and compaction may be accomplished by compacting the composition in place, such by vibration or ramming. De-airing may also be accomplished by forking the composition (using a forking tool or similar apparatus) in order to remove air entrained in the DRC during pouring. The removal of entrained air brings the particles into better contact with one another and provides particle packing sufficient to allow formation of strong bonds and the development of load bearing capability (if desired) in the bonded refractory. The de-aired and compacted DRC is then heated to temperature in any of the various ways known to those skilled in the art (or hereafter developed) in order to form thermal bonds and sinter the DRC, either throughout its entire thickness or in one or more desired regions (e.g., the region nearest the hot face of a working lining formed from the DRC).

Compositions of the present disclosure have levels of respirable (<10 μm) crystalline silica of <5%, <4%, <3%, <2%, <1%, <0.8%, <0.6% <0.4%, <0.2%, <0.1%, <0.08%, <0.06%, <0.04%, <0.02% or <0.01%. In comparison, conventional silica-based DRCs include >5% respirable crystalline silica. In some embodiments, compositions described herein have little or no detectable levels of respirable crystalline silica.

In addition to reduced levels of respirable crystalline silica, the DRCs described herein have an advantageous combination of other properties, including improved volume stability and containment of molten material, as well as strength.

Fused silica is a non-crystalline (amorphous) form of silicon dioxide, having a highly cross-linked, three-dimensional amorphous structure. It is generally synthesized by pyroprocessing high purity quartz sand in an electric arc melting furnace at very high temperatures. Some typical properties of fused silica include high use temperature, low thermal expansion, and good chemical inertness. In addition, fused silica, even if of respirable size, does not pose the same health risks as respirable crystalline silica. It is classified as a material with low toxicity and is even an FDA-Approved food additive.

Given the health risks associated with crystalline silica, it might be tempting to simply use fused silica in place of crystalline silica (i.e., quartz) throughout the entire silica-based DRC (i.e., for all size fractions of the silica aggregate). However, there are problems with this approach.

Quartz mineralogy is advantageous in DRCs due, in part, to its thermal expansion properties. For example, if the thermal expansion of a working lining of an iron furnace is too high, the lining will grow out of the furnace at iron melting temperatures. On the other hand, if the thermal expansion is too low, the DRC lining may not contain the liquid metal load it supports (i.e., some thermal expansion of the lining is needed).

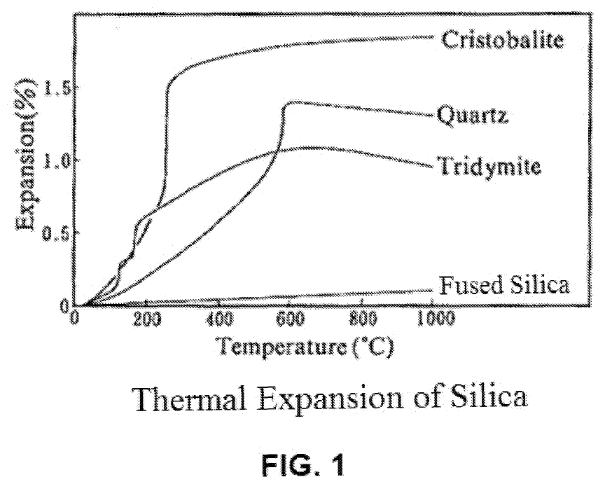

As seen in FIG. 1, fused silica exhibits very low thermal expansion as compared to the three forms of crystalline silica (quartz, cristobalite and tridymite). However, starting at a temperature of about 1100° C. (˜2000° F.) (well below the melting point of, for example, iron), fused silica begins to crystallize (devitrify), forming cristobalite. As also seen in the figure below, cristobalite exhibits significantly greater thermal expansion compared to fused silica. Thus, as fused silica converts to cristobalite, the fused silica grains will expand in size. Even more significantly, as cristobalite cools, it undergoes a phase change from the beta form to the alpha form of cristobalite, resulting in dramatic shrinkage. While quartz also converts to cristobalite, it does so more slowly and requires a higher temperature than does fused silica. Also, the difference in thermal expansion between quartz and cristobalite is not as great as between fused silica and cristobalite.

These thermal properties of fused silica and cristobalite are problematic for a silica-based DRC working lining wherein the aggregate is 100% fused silica across the entire particle size distribution. First, even though some of the fused silica will devitrify to form cristobalite at high temperature, such a working lining will not exhibit sufficient thermal expansion for containment of the liquid metal load it must support—particularly in those regions that are not exposed to high enough temperatures to devitrify the fused silica. Then, upon cooling, such as when the furnace is shut down, a silica-based working lining having only fused silica will crack as cristobalite converts from the beta to alpha forms and shrinks.

However, if the use of fused silica in a silica-based DRC is confined to the smaller particle size fractions of the silica aggregate (e.g., <4 mesh, <10 mesh, <20 mesh, <30 mesh, <40 mesh, or <50 mesh), particularly if the total amount of fused silica is <60% by wt. (or ≤55%, or ≤50%) and the amount of quartz in the smaller particle size fractions (e.g., <30 mesh, ≤50 mesh or <100 mesh) is significantly reduced, the above-described thermal expansion properties and shrinkage of cristobalite with cooling are less problematic. In fact, testing has shown that such DRCs have improved strength following thermal cycling as compared to conventional silica-based DRCs. The DRCs of the present disclosure exhibit lower total expansion upon heating to operating temperatures, but still have enough expansion to provide sufficient compression for containment of the liquid metal load. Also, by confining the fused silica to the smaller particle sizes, the significantly greater expansion of fused silica as it converts to cristobalite is more readily accommodated since the small particles are generally able to expand into the air voids between the larger aggregate particles. At the same time, there are little or no large grains of fused silica that would be unable to expand into any air voids upon forming cristobalite, and would later fall apart (i.e., self-destruct) as the lining cools and the large cristobalite grains shrink.

In addition to addressing the thermal expansion/contraction concerns resulting from the use of fused silica, the silica-based DRCs of the present disclosure have reduced levels of respirable crystalline silica (i.e., crystalline silica <10 μm in size). The DRCs of the present disclosure also have reduced levels of crystalline silica in the non-respirable, yet fine or small (<270 mesh, <100 mesh, <50 mesh or <30 mesh) sizes of the silica aggregate. This aspect facilitates DRC formulation from commercially available, refractory grade quartz while maintaining the desired low levels of respirable crystalline silica.

Quartz is commercially available in a variety of grades and sizes, with the particle sizes typically specified in terms of mesh size or particle size (in mm). Mesh size is indirectly based on the size of the openings in a wire mesh screen used in separating particles by size. For example, a 4-mesh screen has four openings per linear inch of screen. As the mesh size increases, the number of openings in a given area of the screen increases, and hence the size of the particles that will pass through those openings decreases. A “100 mesh” cut of commercially available, refractory grade quartz means that a majority of the particles would pass through a 100 mesh screen—i.e., the majority of the quartz particles in the cut are <100 mesh (<˜0.15 mm) in size. Similarly, −18/+35 mesh lot of quartz means that all of the particles passed through an 18 mesh screen, but were retained on a 35 mesh screen—i.e., the quartz particles are 18-35 mesh (1.0-0.5 mm) in size.

The sizing of mineralogical particulate materials is not 100% precise, particularly in the case of refractory grade quartz such as that used in the manufacture of DRCs for induction furnace working linings. Invariably, a portion of the particles in any lot of refractory grade quartz will be outside of the specified mesh size—especially particles that are finer than the smallest specified size (e.g., smaller than 35 mesh in a −18/+35 lot). This occurs, for example, when finer particles stick to larger ones during the screening process. As a result, for a typical lot of −18/+35 mesh refractory grade quartz, typically up to about 15-20% (by weight) of the particles will be smaller than 35 mesh—including some particles that are <10 μm (i.e., are respirable).

Suppliers of mineralogical particulate materials such as quartz do provide a sieve analysis for each their product sizes, including a breakdown of the amount of various size fractions that are smaller than the specified size (e.g., the % of particles in their −18/+35 mesh quartz that are smaller than 50 mesh, smaller than 100 mesh, etc.). However, such sieve analyses typically stop at around 270 mesh (0.053 mm)—well above the size of respirable crystalline silica—reporting everything smaller than 270 mesh as “pan” (i.e., the amount of material that passed through all of the screens into a “pan” beneath the bottom screen). For example, a sieve analysis for commercially available, refractory grade −18/+35 mesh quartz will typically report the product as containing “0 to 5% Pan,” meaning that up to 5% by weight of the quartz is smaller than 270 mesh (˜50 μm). While most of the “0 to 5% Pan” of quartz will be larger than respirable size (≥10 μm), a purchaser formulating a DRC using commercially available quartz will not know how much of the quartz in the “0 to 5% Pan” is of respirable size. It is impractical for a supplier of mineralogical particulate materials to analyze every lot for the amount of crystalline silica particles that are <10 μm in size. It is equally impractical for a manufacturer of DRCs to analyze every product batch for the amount of particles that are <10 μm in size, let alone the amount of one component (respirable crystalline silica) that is <10 μm in size.

Of course, it is important to have a wide distribution of particle sizes of silica in a silica-based DRC, including particles smaller than 100 mesh (˜50 μm) as well as particles larger than 30 mesh (˜0.6 mm). Large particles are important in that they provide increased expansion of the lining (since there are no air voids large enough for the particles to expand into) that helps to hold the lining in place, as well as being more difficult for molten metal to penetrate. Small particles are important for providing optimal particle packing (i.e., reduced air pockets between particles) and performance of the working lining. Accordingly, DRCs according to some embodiments of the present disclosure require about 25-40% of silica aggregate that is smaller than 100 mesh (0.149 mm). However, it is not practical to include a sufficient quantity of quartz <100 mesh to meet the particle size distribution requirements for product performance while maintaining a low level (e.g., <1%) of respirable (<10 μm) quartz particles. Similarly, for DRCs formulated to have very little or no detectable respirable crystalline silica (e.g., <0.1%), commercially available, refractory grade quartz specified as being ≥100 mesh (or, in some instances, ≥50 mesh) in size will still have too many quartz particles <10 μm to achieve the desired level of respirable crystalline silica while also providing sufficient silica aggregate in, for example, the −30/+100 size range to meet the particle size distribution requirements for product performance.

Accordingly, it is not practical to formulate a silica-based DRC with a significantly reduced level of respirable crystalline silica, while also having a consistent ratio of quartz to fused silica (e.g., ˜2:1) for all particle sizes ≥10 μm. Thus, in addition to having a low level (e.g., <1%) of crystalline silica <10 μm in size, DRCs according to embodiments of the present disclosure also have reduced levels of crystalline silica less than 100 mesh in size. In embodiments having a very low level (e.g., <0.2% of crystalline silica <10 μm) in size, DRCs according to embodiments of the present disclosure also have reduced levels of crystalline silica less than 50 mesh (or, in some instances, less than 30 mesh) in size.

The table below provides exemplary silica-based DRCs according to the present disclosure, wherein the compositions comprise, consist essentially of, or, in some instances, consist of (as a wt. % of the total composition):

| | Group A | Group B | Group C | Group D | Group E | Group F |
|---|---|---|---|---|---|---|
| Silica (as a defined | 95-99.9% | 97-99.7% | 98.5-99.4% | 98.2-99.6% | 97.5-99.4% | 100% |
| combination of quartz | | | | | | |
| and fused silica) | | | | | | |
| Binder | 0.1-5% | 0.3-3% | 0.6-1.5% | 0.4-1.8%, | 0.6-2.5%, | 0% |
| | | | | as boron | as boric | |
| | | | | oxide | acid | |

The compositions of Group F above (100% silica aggregate, with no binder) can be used as a so-called “no-bond” DRC, such as for the working lining of the subfloor of an induction furnace. For each of the above-described groups A-F of compositions, the silica comprises, consists essentially of, or, in some instances, consists of any of the quartz and fused silica combinations in the table below (as a wt. % of the total silica):

| | Subgroup | Subgroup | Subgroup | Subgroup |
|---|---|---|---|---|
| | 1 | 2 | 3 | 4 |
| Quartz | 40 to 80% | 45 to 75% | 50 to 70% | 55 to 65% |
| Fused | 20 to 60% | 25 to 55% | 30 to 50% | 35 to 45% |
| silica | | | | |

Accordingly, a C-2 composition according to embodiments of the present disclosure comprises, consists essentially of, or consists of: 98.5 to 99.4% silica by weight and 0.6 to 1.5% binder, wherein 45 to 75% of the silica is quartz and 25 to 55% of the silica is fused silica. Thus, compositions of the present disclosure include A-1, A-2, A-3, A-4, B-1, B-2, B-3, B-4, C-1, C-2, C-3, C-4, D-1, D-2, D-3, D-4, E-1, E-2, E-3, E-4, F-1, F-2, F-3 and F-4.

In the above-described DRCs (A-1, A-2, etc.), the level of respirable (<10 μm) crystalline silica is <5%, <4%, <3%, <2%, <1%, <0.8%, <0.6% <0.4%, <0.2%, <0.1%, <0.08%, <0.06%, <0.04%, <0.02% or ≤0.01%. The level of respirable crystalline silica can be determined, for example, using X-ray diffraction.

It should also be noted that it is not possible to ensure that there is 0% respirable crystalline silica in the final DRC. Not only is it likely that at least a small amount of respirable crystalline silica will be present, for example, on the surface of larger quartz particles, during the process of manufacturing fused silica not all of the silica is transformed into fused silica and some cristobalite may remain. Thus, it is still possible to have trace amounts of respirable crystalline silica in the DRCs of the present disclosure.

As explained previously, DRCs typically comprise refractory aggregate having a range of sizes—a distribution of sizes ranging from fine powders (e.g., <5 μm or smaller) up to around 20 mm in size (occasionally up to around 40 mm)—in order to, among other things, provide optimal packing within a void during installation. In some embodiments of the above-described DRCs (A-1, A-2, etc.), the silica (as quartz and fused silica) aggregate has the following size distribution (in weight percent, wherein all but the smallest size fraction are reported as cumulative amounts):

| | Distribution | Distribution | Distribution | Distribution |
|---|---|---|---|---|
| | (a) | (b) | (c) | (d) |
| ≥⅜″ | 0-10% | 1-8% | 0% | 0% |
| (8 mm) | | | | |
| ≥4 mesh | 0-25% | 12-22% | 0-1% | 0-1% |
| (4.76 mm) | | | | |
| ≥30 mesh | 40-60% | 50-60% | 44-50% | 40-50% |
| (0.595 mm) | | | | |
| ≥100 mesh | 60-75% | 65-75% | 60-70% | 65-75% |
| (0.149 mm) | | | | |
| <100 mesh | 25-40% | 25-35% | 30-40% | 15-25% |
| (0.149 mm) | | | | |

In addition to having low levels of respirable crystalline silica, in the above-described DRCs (A-1, A-2, etc.), the amount of crystalline silica less than 100 mesh (0.149 mm) is also low; for example <5%, <4%, <3%, <2%, <1%, <0.8%, <0.6% <0.4%, <0.2%, or <0.1%. This aspect of DRCs according to some embodiments of the present disclosure is obtained, for example, by formulating the composition using no −100 mesh quartz (i.e., using no quartz that passed through a 100 mesh or smaller screen during sieve sizing). (Even though no quartz that passed through a 100 mesh or smaller screen during sieve sizing is used in the product, there will still be some amount of quartz <100 mesh in the final composition due to, for example, fine particles that clung to >100 mesh size particle during sieve sizing.)

In still further embodiments of the above-described DRCs (A-1, A-2, etc.), not only is the level of respirable crystalline silica very low (e.g., <0.2%, <0.1%, <0.08%, <0.06%, <0.04%, <0.02% or ≤0.01%), the amount of crystalline silica less than 50 mesh (or, in some instances, <30 mesh) in such DRCs is also low; for example <3%, <1%, <0.8%, <0.6% <0.4%, <0.2%, or <0.1%, <0.08%. This aspect of DRCs according to some embodiments of the present disclosure is obtained, for example, by formulating the composition using no −50 mesh quartz (or no −30 quartz)—i.e., using no quartz that passed through a 50 mesh or smaller (or 30 mesh or smaller) screen during sieve sizing.

At the upper size range of silica aggregate in the above-described DRCs (A-1, A-2, etc.), there is no fused silica in the portion ≥4 mesh (4.76 mm). In some embodiments, there is no fused silica that is ≥10 mesh (2.00 mm). In other embodiments, there is no fused silica that is ≥14 mesh (1.4 mm). In still further embodiments, there is less than 10%, less than 5%, less than 1%, less than 0.5%, less than 0.1%, or 0% fused silica that is ≥30 mesh (0.595 mm). In still further embodiments, there is less than 35%, less than 30%, less than 20%, less than 10%, less than 5%, or less than 1% fused silica that is ≥50 mesh (0.595 mm).

As noted above, embodiments of the DRCs of the present disclosure also include one or more inorganic binders (also referred to as a bonding agent) that provide heat activated bonding. Suitable inorganic bonding agents include boron containing chemical compounds such as boric acid, boron oxide, metaborate, borinic acid, sodium borate, and potassium fluoroborate and combinations thereof. Other suitable inorganic binders (or bonding agents) include cryolite, a noncalcium fluoride salt (e.g., aluminum fluoride or magnesium fluoride), a silicate compound (e.g., sodium silicate or potassium silicate), a phosphate compound (e.g., dry orthophosphate powder), calcium silicate, calcium aluminate, magnesium chloride, ball clay, kaolin, a sulfate compound (e.g., aluminum sulfate, calcium sulfate, or magnesium sulfate), a metal powder (e.g., powdered aluminum or silicon alloys), and refractory frit. Combinations of one or more of the foregoing binders can also be used. Other heat activated bonding agents recognized in the art (or hereafter developed) also may be used. The particle size of the bonding agent is typically less than about 100 mesh, or in some instances less than about 200 mesh, as finer particles provide better dispersion and, where needed, a faster rate of reaction.

Boron oxide and boric acid are particularly useful inorganic bonding agents. Boron oxide and boric acid react with the silica (quartz and fused silica) and lower the melting point of the silica. This creates a dense borosilicate glass liquid layer that helps prevent the molten iron from penetrating into the refractory. This borosilicate glass fills around larger unreacted silica particles and lowers the porosity at that interface. These types of binders are also referred to as sintering aids.

In addition to the targeted use of fused silica within certain size fractions for thermal expansion considerations as well as to allow for the formulation of DRCs having reduced levels of respirable crystalline silica, some (but not all) embodiments of the present disclosure use a particular type of fused silica. Applicants have found that not all fused silica performs in the same manner when used in the DRCs of the present disclosure. In particular, while the fused silica is preferably of high purity (>99%, >99.5% or even >99.8%), applicants have also found that the method of manufacturing the fused silica and/or the composition of the quartz sand starting material can affect certain physical properties of the fused silica and certain properties of DRCs according to the present disclosure.

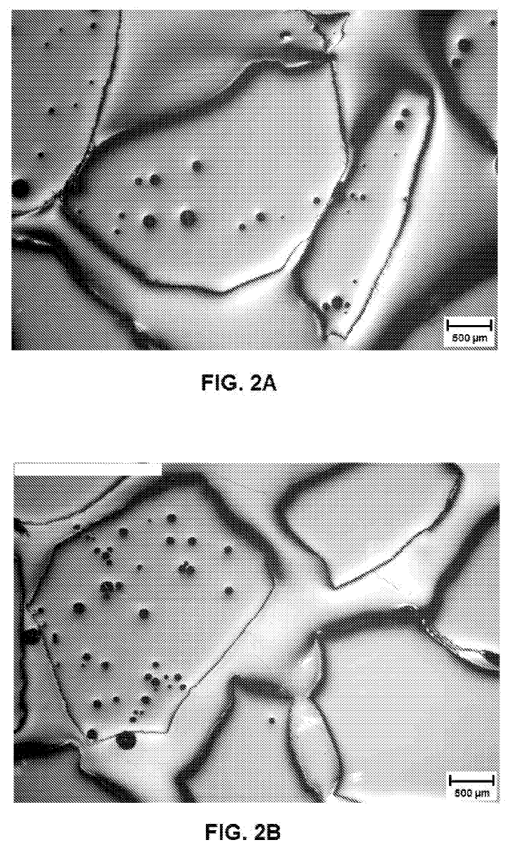

FIGS. 2A and 2B provide reflected light images of fused silica (−4/+10 mesh) from two different sources (“Type A” and “Type B”), captured using a compound microscope. The samples (A and B) were prepared in the same manner: particles were embedded in epoxy and, following curing of the epoxy, polished to a provide a flat surface.

The composition of the Type A and Type B fused silica materials, as tested by X-ray fluorescence and X-ray diffraction, as well as the crystallinity and density (as reported by the suppliers) was comparable (although Type B did have slightly less impurities than Type A—99.9% purity for Type B vs. 99.5% purity for Type A). However, in Type A (FIG. 2A) the pores were more broadly distributed throughout the fused silica grains while in Type B (FIG. 2B) most (>50%) of the grains had no visible pores. Approximately 90% of the grains in the Type A fused silica had five or more pores at least 10 μm in size. In contrast, only about 10% of the grains in the Type fused silica had five or more pores at least 10 μm in size.

While not wishing to be bound by theory or supposition, applicants believe that the differences in pore distributions among the grains of fused silica is a result of the nature and size of the reactor used to produce the fused silica (and perhaps the composition of the quartz sand raw material). Type A is believed to have been produced using a rotating arc furnace, while Type B is believed to have been produced using a larger, stationary furnace employing a single carbon electrode heating element (rather than heating using a high voltage arc between two electrodes, as in an arc furnace). Thus, the fused silica of Type A was produced as a smaller ingot, with a wider distribution of pores within the fused silica grains, as compared to Type B. It is also believed that Type A was produced using a finer (smaller) quartz sand feedstock. Fused silica similar to Type A is available, for example, from Precision Electro Minerals Co., Imerys Refractory Minerals (as Teco-Sil® fused silica), and 3M.

Applicants have discovered that fused silica having pores more broadly distributed throughout the fused silica grains can provide a DRC that is more resistant to cracking due to repeated thermal shocks. Thus, DRCs of the present disclosure that employ fused silica having pores more broadly distributed throughout the fused silica grains are expected to have a longer useful life. In the case of a working lining of an induction furnace, this means that the working lining can be used for a greater number of metal production runs (also referred to as “heats”) before failure (i.e., are able to withstand more thermal shocks, and hence more thermal cycles). While not wishing to be bound by theory, applicants believe that the improved resistance to cracking for DRCs made using Type A fused silica having a wide distribution of pores results from slightly lower thermal conductivity, which results in a slower rate of cristobalite formation. Also, the broader distribution of pores within the Type A fused silica grains may also hinder crack propagation when the material is subjected to high stress gradients such as those induced by thermal shock, thereby further helping to prevent premature cracking of a working lining.

As used herein, a “broad pore distribution fused silica” means a type of fused silica that, in a sample of having a particle size of between 4 and 10 mesh, at least 50% of the grains have five or more pores at least 10 μm in size. As also used herein, a “>60% pore distribution” fused silica means a type of silica that, in a sample of having a particle size of between 4 and 10 mesh, at least 60% of the grains have five or more pores at least 10 μm in size. A “>70% pore distribution,” “>80% pore distribution,” and “≥90% pore distribution” fused silica are similarly defined.

Thus, while it is not desirable to use fused silica for the entirety of the silica aggregate in a silica-based DRC, and not in the larger sizes of aggregate, the targeted use of fused silica within certain smaller size fractions (including, in some embodiments, the entirety of the aggregate smaller than 100 mesh, or smaller than 50 mesh) provides beneficial properties that are in addition to reduced levels of respirable crystalline silica. In some embodiments, these benefits are further enhanced when the fused silica employed in the DRC is a broad pore distribution fused silica—e.g., a fused silica having a >50%, >60%, >70%, >80% or ≥90% pore distribution, as defined above.

Some embodiments of the present disclosure provide DRCs that comprise or consist essentially of silica (as a combination of quartz and fused silica) and inorganic binder. These compositions may contain small amounts of one or more processing aids. By way of example, in some embodiments of the present disclosure, the compositions described above include a plus addition of mineral oil or other dust suppressant—e.g., a plus addition of up to about 0.1 parts of mineral oil per 100 parts of the DRCs described above (i.e., 100 parts prior to the addition of the mineral oil). Other suitable dust suppressants include other lightweight oils (e.g., canola oil), kerosene, glycols, nonaqueous viscous organic polymers, or combinations of any of the foregoing.

Further embodiments of the present disclosure provide DRCs that comprise or consist essentially of silica (as a combination of quartz and fused silica) and inorganic binder, in the various amounts and sizes disclosed above, along with a plus addition of metal fibers. As described in U.S. Pat. No. 6,893,992, incorporated by reference herein, such an addition of metal fibers will, in some instances, decrease the brittle characteristics of a bonded portion of the installed composition and resist cracking. In some embodiments, about 0.5 to about 15 parts (by weight) of metal fibers are added to 100 parts of the DRC (i.e., 100 parts prior to the addition of the metal fibers). Suitable metals for the fibers include one or more of: stainless steel; carbon steel; chromium alloy; copper alloy; aluminum alloy; and titanium alloy. The metal fibers typically have a length of about ½ to about 2 inches, and a combination of fiber lengths, whether of a single metal composition or a combination of metal compositions, may be used. The metal fibers typically are added to the ingredients of the DRC during mixing of the other components.

The DRCs of the present disclosure can be installed in the same manner as a conventional DRC. In particular, working linings for electric induction furnaces typically are installed in a two-step process. First, the DRC is installed onto the floor portion of the furnace, followed by de-airing and compaction of the floor layer. Second, the walls of the refractory lining are fashioned using a form that is positioned on the installed floor, typically as multiple layers, followed by de-airing and compaction of each layer. The form defines a void located between the inner wall of the working lining and the inner wall of the furnace defines the outer wall of the refractory lining. The form may be removable or consumable. Consumable forms typically are used for higher temperature applications (i.e., greater than about 2000° F.) when the melted form can be used as part of the molten metal product. Consumable forms also are used when removal of a form would not be feasible after refractory installation, for example, in the inductor of a channel furnace.

In conventional installation methods, the DRC is poured into the void followed by de-airing and compaction. The DRC can be manually de-aired, such as by forking or spading, followed by compaction using an electric vibrating tamper or form vibration. This process is typically done in layers having a depth of about 3-5 inches, with each layer compacted before the next layer of loose DRC is added. By way of example, an electric vibrating tamper, such as a Bosch vibrator, can be used for compaction. Alternatively, form vibration can be used for compaction, particularly in larger furnaces. As yet another alternative, the apparatus and method described in U.S. Pat. No. 6,743,382, incorporated by reference herein, can be used for de-airing and compaction of the DRCs of the present disclosure.

Following de-airing and compaction, the DRC is heated to temperature (e.g., about 700 to about 1200° C. in order to form thermal bonds such that the form can be removed. In the case of consumable forms, the DRC is heated beyond 1200° C. to sinter the DRC, either throughout its entire thickness or in one or more desired regions (e.g., the region nearest the hot face of a working lining formed from the DRC).

### Example 1

A DRC was prepared by blending, on a weight % basis:
59.5% quartz having a mesh size between 4 mesh (4.76 mm) and 100 mesh (0.149 mm);
39.5% Type A fused silica having a mesh size of less than 50 mesh (0.297 mm) and finer; and
1.0% boron Oxide.
   The amount of respirable crystalline silica was determined using X-ray diffraction for both the above-described DRC according to the present disclosure. The amount of respirable crystalline silica in two commercially available DRCs, from two different manufacturers made entirely of quartz and binder, was also determined. The commercially available DRCs had 7.18% and 9.02% by weight respirable crystalline silica (i.e., <10 μm), while the DRC according to the present disclosure had only 0.03% by weight respirable crystalline silica.

### Example 2

The properties of the DRC of Example 1 were compared to that of a commercially available DRC made entirely of quartz and binder, using a modified version of ASTM C1171. An additional binder was added to the DRCs in order to allow the material to be handled and pressed into bars at room temperature. The additional binder was added only for testing the properties of the DRC.

Bars were pressed from each of the two DRCs (1×1×6 inches) and dried overnight at 230° F. Next, the bars were prefired to 2200° F. and held for 5 hours, then cooled to room temperature. The length, width and thickness of each bar were measured, and five bars of each material were selected at random for thermal shock testing. The bars were subjected to five cycles of thermal shock by placing the bars in a furnace heated to 2200° F. for 10-15 minutes, removing the bars from the furnace and allowing them to cool at room temperature for 10-15 minutes, and repeating the process four additional times. The cold (room temperature) modulus of rupture (“CMOR”) was measured for shocked and unshocked bars.

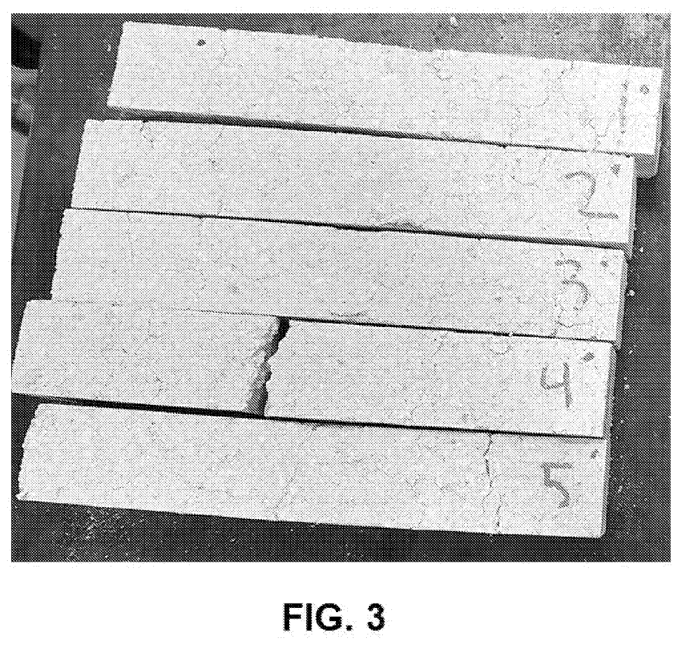

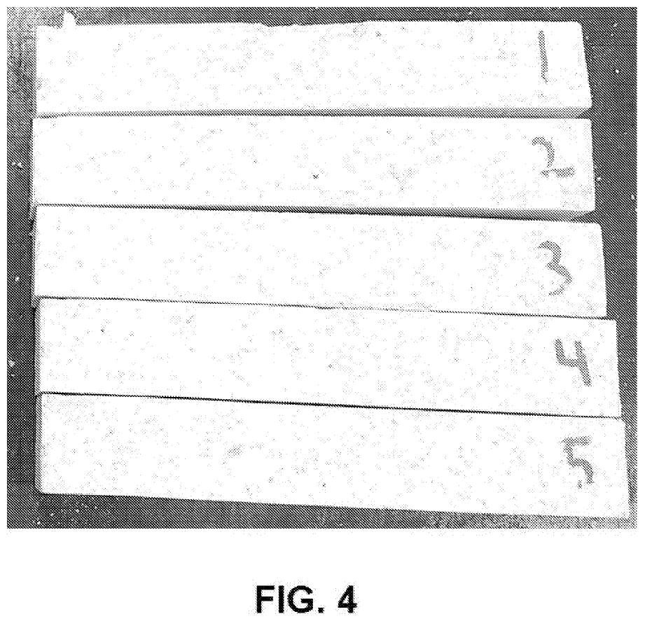

The unshocked bars formed using the commercially available DRC and the DRC of Example 1 had similar CMORs (309 psi and 246 psi, respectively). However, following the five cycles of thermal shock, there was a significant difference in the bars. The photographs of FIG. 3 are of the bars produced from the commercially available DRC after five cycles of thermal shock (prior to CMOR testing), and FIG. 4 provides photographs of the bars produced from the DRC of Example 1 after five cycles of thermal shock (prior to CMOR testing). As seen in FIGS. 3 and 4, the bars made from a commercially available DRC exhibited a significant amount of cracking, including one bar that split into two pieces. In contrast, the bars made from the DRC (Example 1) according to the present disclosure displayed no cracking from the five cycles of thermal shock.

The above data demonstrates that DRCs of the present disclosure that not only have reduced levels of respirable crystalline silica, but also a targeted distribution of fused silica and quartz, provide superior performance—especially strength following thermal shock—as compared to commercially available DRCs using 100% quartz as the silica aggregate.

The example and specific embodiments set forth herein are illustrative in nature only and are not to be taken as limiting the scope of the invention defined by the following claims. Additional specific embodiments and advantages of the present invention will be apparent from the present disclosure and are within the scope of the claimed invention.

While various embodiments of DRCs have been described in detail above, it will be understood that the components, features and configurations, as well as the methods of manufacturing the devices and methods described herein are not limited to the specific embodiments described herein.

1. A silica-based dry refractory composition (“DRC”) comprising silica and optionally a binder, wherein said silica comprises, by weight:
about 40% to about 80% quartz, and
about 20% to about 60% fused silica;
wherein said DRC has less than about 5% crystalline silica having a size less than 10 μm,
and further wherein said DRC is adapted for installation into a void without the addition of water or liquid chemical binder such that, when heated, at least a portion of the DRC forms thermal bonds and sinters.

2. (canceled)

3. The DRC of claim 1, wherein said DRC has <1% crystalline silica having a size less than 10 μm.

4. (canceled)

5. The DRC of claim 1, wherein said DRC comprises, by weight, about 95% to about 99.9% silica, and about 0.1 to about 5% binder.

6-7. (canceled)

8. The DRC of claim 1, wherein said DRC consists essentially of about 98.2% to about 99.6% silica, and about 0.4 to about 1.8% binder, and further wherein said binder is boron oxide.

9. The DRC of claim 1, wherein said DRC consists essentially about 97.5% to about 99.4% silica, and about 0.6 to about 2.5% binder, and further wherein said binder is boric acid.

10-12. (canceled)

13. The DRC of claim 1, wherein said silica has the following particle size distribution, by weight:

| | |
|---|---|
| ≥⅜″ | 0% to about 10% |
| ≥4 mesh | 0% to about 25% |
| ≥30 mesh | about 40% to about 60% |
| ≥100 mesh | about 60% to about 75% |
| <100 mesh | about 25% to about 40%. |

14-16. (canceled)

17. The DRC of claim 13, wherein said DRC has less than about 5% crystalline silica having a size less than 100 mesh.

18-19. (canceled)

20. The DRC of claim 17, wherein said DRC has less than about 3%, crystalline silica having a size less than 50 mesh.

21. (canceled)

22. The DRC of claim 1, wherein said DRC has no fused silica that is 4 mesh or larger.

23-25. (canceled)

26. The DRC of claim 22, wherein said DRC has less than about 35% fused silica that is 50 mesh or larger.

27. The DRC of claim 5, wherein said binder is chosen from the group consisting of:
a boron containing chemical compound;
cryolite;
a noncalcium fluoride salt;
a silicate compound;
a phosphate compound;
calcium silicate;
calcium aluminate;
magnesium chloride;
ball clay;
kaolin;
a sulfate compound;
a metal powder; and
refractory frit.

28. The DRC of claim 27, wherein said binder comprises a boron containing chemical compound chosen from the group consisting of boron oxide, boric acid, metaborate, borinic acid, sodium borate, and potassium fluoroborate.

29-30. (canceled)

31. The DRC of claim 5, wherein said DRC consists essentially of silica and a binder chosen from the group consisting of: boron oxide, boric acid or a combination of boron oxide and boric acid.

32-33. (canceled)

34. The DRC of claim 1, wherein said fused silica comprises a broad pore distribution fused silica.

35. (canceled)

36. The DRC of claim 34, wherein said fused silica comprises a >70% pore distribution fused silica.

37. The DRC of claim 1, further comprising a plus addition of a dust suppressant.

38. (canceled)

39. The DRC of claim 1, further comprising a plus addition of metal fibers.

40-42. (canceled)

43. A method of forming a refractory lining, comprising the steps of:
(a) adding the DRC of claim 1 to a void, without adding water or liquid chemical binder;
(b) de-airing and compacting the DRC within the void; and
(c) heating the DRC within the void to form the lining within the void.

44. The method of claim 43, wherein said DRC includes a binder such that, upon heating the DRC within the void, at least a portion of the DRC forms thermal bonds and sinters.

45. The method of claim 44, wherein said at least a portion of the DRC is heated to a temperature of at least about 700° C.

46. (canceled)

48. The method of claim 44, further comprising the step of cooling the lining, wherein, following cooling, a portion of the lining remains in an unsintered and unbonded state.
